(19) United States
(12) Patent Application Publication
(10) Pub. No.: US 2019/0368790 A1
(43) Pub. Date: Dec. 5, 2019

(54) FOUR-WAY VALVE

(71) Applicant: Carrier Corporation, Palm Beach Gardens, FL (US)

(72) Inventors: Sathish R. Das, Indianapolis, IN (US); Charles A. Cluff, Zionsville, IN (US)

(21) Appl. No.: 16/431,010

(22) Filed: Jun. 4, 2019

Related U.S. Application Data
(60) Provisional application No. 62/680,770, filed on Jun. 5, 2018.

(51) Int. Cl. F25B 41/04; F25B 49/02

(52) U.S. Cl. CPC F25B 41/046; F16K 11/0655; F25B 2313/02741; F25B 49/02

(57) ABSTRACT

A heating and cooling system includes a compressor having a discharge outlet and a suction inlet; a first heat exchanger; a second heat exchanger; a four-way valve including: a body including a first port connected to the discharge outlet, a second port connected to the first heat exchanger, a third port connected to the suction inlet and a fourth port connected to the second heat exchanger; a slider positioned in the body; and an actuator assembly configured to impart linear motion to the slider; and a controller configured to send a command to the actuator assembly to move the slider to one of a first position, a second position or a third position.

### CROSS-REFERENCE TO RELATED APPLICATIONS

This application claims the benefit of U.S. provisional patent application Ser. No. 62/680,770, filed Jun. 5, 2018, the entire contents of which are incorporated herein by reference.

### BACKGROUND

The embodiments disclosed herein relate to four-way valves for use with heating and cooling systems.

Existing heating and cooling systems (e.g., heat pump systems) may utilize a reversing valve to switch refrigerant flow between heating mode and cooling mode. An existing reversing valve designed for use in a heat pump uses a solenoid to shift a pilot valve that directs pressurized refrigerant to control a pressure-driven shift of the main valve. The shifting of the main valve diverts the refrigerant for either the heating mode or the cooling/defrost mode. The solenoid valve, however, has to remain energized while the system is running in one of the cooling mode or heating mode positions, thus wasting energy. Pressure differential assisted valves (also referred to as pilot assisted) are designed to operate in one of only two positions. Further, these valves may not shift properly if the pressure differential is not sufficient, and can become stuck in a middle position. This is especially true in systems, such as, variable speed (or stage) systems and variable mass flow systems.

The shift in valve position must occur while the system is operating. Refrigerant flow during valve transition can potentially cause flow of liquid refrigerant toward the suction inlet of the compressor and compromise system reliability or require additional components such as an accumulator to catch the liquid refrigerant.

### BRIEF SUMMARY

According to an embodiment, a heating and cooling system includes a compressor having a discharge outlet and a suction inlet; a first heat exchanger; a second heat exchanger; a four-way valve including: a body including a first port connected to the discharge outlet, a second port connected to the first heat exchanger, a third port connected to the suction inlet and a fourth port connected to the second heat exchanger; a slider positioned in the body; and an actuator assembly configured to impart linear motion to the slider; and a controller configured to send a command to the actuator assembly to move the slider to one of a first position, a second position or a third position.

In addition to one or more of the features described herein, or as an alternative, further embodiments may include, wherein when the slider is in the first position, the third port is fluidly coupled to the fourth port, the first position corresponding to a cooling mode.

In addition to one or more of the features described herein, or as an alternative, further embodiments may include, wherein when the slider is in the second position, the second port is fluidly coupled to the third port, the second position corresponding to a heating mode.

In addition to one or more of the features described herein, or as an alternative, further embodiments may include, wherein when the slider is in the third position, the second port is fluidly coupled to the fourth port, the third position corresponding to a shutdown mode.

In addition to one or more of the features described herein, or as an alternative, further embodiments may include, wherein the actuator assembly comprises a stepper motor and a worm gear.

In addition to one or more of the features described herein, or as an alternative, further embodiments may include, wherein the slider comprises a geared surface to coact with the worm gear.

In addition to one or more of the features described herein, or as an alternative, further embodiments may include, wherein the actuator assembly is configured to move the slider when the compressor is not running.

According to another embodiment, a four-way valve includes a body including a first port configured to connect to a discharge outlet of a compressor, a second port configured to connect to a first heat exchanger, a third port configured to connect to a suction inlet of the compressor and a fourth port configured to connect to a second heat exchanger; a slider positioned in the body; and an actuator assembly configured to impart linear motion to the slider; wherein the actuator assembly is configured to move the slider to one of a first position, a second position or a third position.

In addition to one or more of the features described herein, or as an alternative, further embodiments of the four-way valve may include, wherein when the slider is in the first position, the third port is fluidly coupled to the fourth port, the first position corresponding to a cooling mode.

In addition to one or more of the features described herein, or as an alternative, further embodiments of the four-way valve may include, wherein when the slider is in the second position, the second port is fluidly coupled to the third port, the second position corresponding to a heating mode.

In addition to one or more of the features described herein, or as an alternative, further embodiments of the four-way valve may include, wherein when the slider is in the third position, the second port is fluidly coupled to the fourth port, the third position corresponding to a shutdown mode.

In addition to one or more of the features described herein, or as an alternative, further embodiments of the four-way valve may include, wherein the actuator assembly comprises a stepper motor and a worm gear.

In addition to one or more of the features described herein, or as an alternative, further embodiments of the four-way valve may include, wherein the slider comprises a geared surface to coact with the worm gear.

In addition to one or more of the features described herein, or as an alternative, further embodiments of the four-way valve may include, wherein the actuator assembly is configured to move the slider when the compressor is not running.

According to another embodiment, a method of controlling a four-way valve including a body including a first port configured to connect to a discharge outlet of a compressor, a second port configured to connect to a first heat exchanger, a third port configured to connect to a suction inlet of the compressor, a fourth port configured to connect to a second heat exchanger, and a slider positioned in the body, the method including in a cooling mode, positioning the slider in a first position to fluidly couple the third port and the fourth port; in a heating mode, positioning the slider in a second position to fluidly couple the second port and the third port; in a shutdown mode, positioning the slider in a third position to fluidly couple the second port and the fourth port.

In addition to one or more of the features described herein, or as an alternative, further embodiments of the method valve may include, wherein the slider is configured to move when the compressor is not running.

Technical effects of embodiments of the present disclosure include a four-way valve that does not rely on system pressure to move from one position to another and that does not require power to remain in a fixed position.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic diagram of a heat pump refrigerant system in an example embodiment;

FIG. 2 depicts a four-way valve in a first position in an example embodiment;

FIG. 3 depicts the four-way valve in a third position in an example embodiment;

FIG. 4 is flowchart of a process for controlling the four-way valve in an example embodiment.

### DETAILED DESCRIPTION

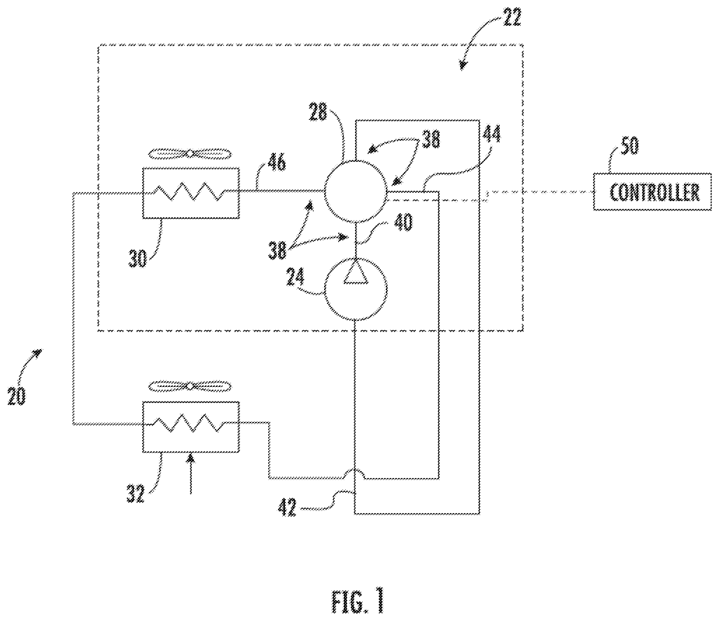

FIG. 1 depicts a heating and cooling system 20 (e.g., a heat pump system) having a compressor 24. While only one compressor 24 is shown, additional compressors may also be incorporated in series. Also, a multi-stage compressor arrangement can be employed and equally benefit from the presently disclosed embodiments. In one embodiment, the system 20 includes an outdoor section 22 including the compressor 24 and an outdoor heat exchanger 30. A four-way valve 28 routes refrigerant from the discharge outlet of the compressor 24 to the outdoor heat exchanger 30 when the system 20 is in a cooling mode. The four-way valve 28 routes refrigerant from the discharge outlet of the compressor 24 to the indoor heat exchanger 32 when the system 20 is in a heating mode. A series of lines 38 are coupled to the four-way valve 28 for flow of refrigerant through the four-way valve 28. The lines include a compressor discharge outlet 40, a compressor suction inlet 42, an indoor heat exchanger line 44, and an outdoor heat exchanger line 46. One or more expansion devices may be located between the outdoor heat exchanger 30 and the indoor heat exchanger 32.

A controller 50 controls operation of the system 20 and the four-way valve 28. When the system 20 calls for cooling, the controller 50 sends a command to the four-way valve 28 to establish a first position fluidly coupling the compressor discharge outlet 40 to the outdoor heat exchanger 30 and fluidly coupling the indoor heat exchanger 32 to the compressor suction inlet 42. When the system 20 calls for heating, the controller 50 sends a command to the four-way valve 28 to establish a second position fluidly coupling the compressor discharge outlet 40 to the indoor heat exchanger 30 and fluidly coupling the outdoor heat exchanger 30 to the compressor suction inlet 42.

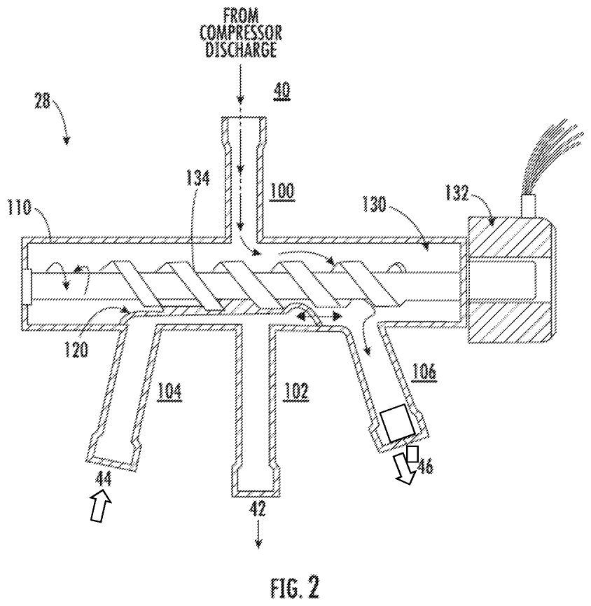

FIG. 2 depicts the four-way valve 28 in an example embodiment. The four-way valve 28 includes a valve body 110 defining an internal chamber and four ports 100, 102, 104 and 106. Port 100 is connected to the compressor discharge outlet 40, port 102 is connected to the compressor suction inlet 42, port 104 is connected to the indoor heat exchanger line 44, and port 106 is connected to the outdoor heat exchanger line 46. Ports 102, 104 and 106 are arranged adjacent to each other on a common axis.

The four-way valve 28 includes a slider 120 to fluidly couple ports 100, 102, 104 and 106 in different combinations. In FIG. 2, the slider 120 is in a first position fluidly coupling the port 100 to port 106 and fluidly coupling port 104 to port 102. The first position corresponds to cooling mode of the system 20. The slider 120 may also be moved to a second position fluidly coupling the port 100 to port 104 and fluidly coupling port 102 to port 106. The second position corresponds to heating mode of the system 20.

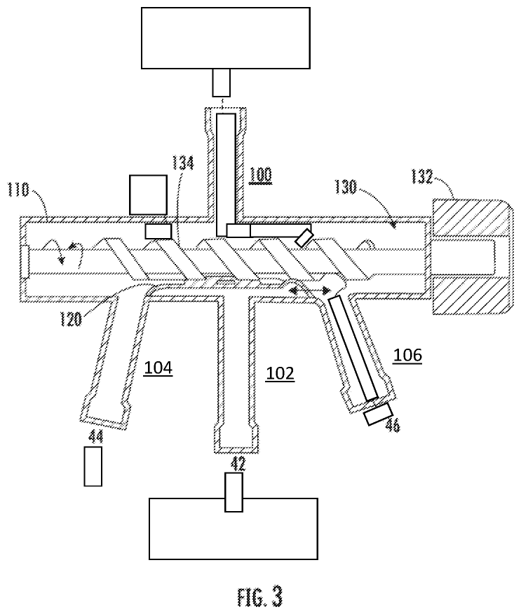

As shown in FIG. 3, the slider 120 may also be positioned in a third position between the first position and the second position. In the third position, the slider 120 spans only port 102, fluidly coupling ports 100, 104 and 106. The third position corresponds to a pressure equalization position which is assumed when the system 20 is shut off. When the slider 120 is in the third position, the high side and low side of the system 20 are in fluid communication, thereby reducing the high side to low side pressure differential. This reduces compressor starting current without requiring separate pressure equalization valves.

The slider 120 is moved in a linear manner by an actuator assembly 130. In the example embodiment of FIGS. 2 and 3, the actuator assembly 130 includes a stepper motor 132 and a worm gear 134. A surface of the slider 120 is geared to coact with the worm gear 134. Rotation of the stepper motor 132 in response to command signals from the controller 50 causes the slider 120 to move in a linear manner (e.g., left or right). It is understood that other types of linear actuators may be used in the actuator assembly 130 to control the position of the slider 120. Embodiments are not limited to the worm gear 134 and stepper motor 132 of FIGS. 2 and 3. Using the actuator assembly 130 allows the slider to be positioned smoothly and accurately without relying on pressure differentials. Once the slider is in the desired position, power to the actuator assembly 130 is no longer needed to keep the slider 120 in position.

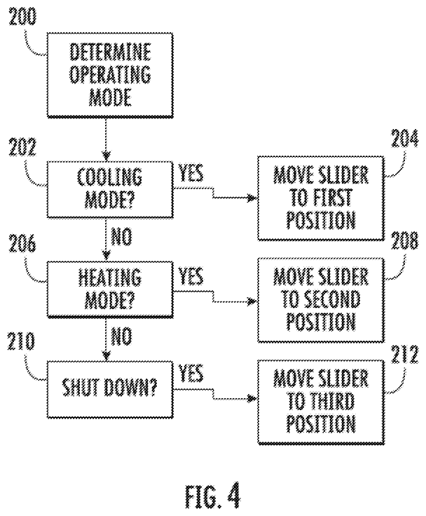

FIG. 4 is a flowchart of a process for controlling the four-way 28 valve in an example embodiment. The process begins at 200 where the controller 50 determines the operating mode of the system 20. If the system 20 is set to operate in cooling mode at 202, then at 204 the controller 50 sends a command to the actuator assembly 130 to place the slider 120 in the first position (as shown in FIG. 2). If the system 20 is set to operate in heating mode at 206, then at 208 the controller 50 sends a command to the actuator assembly 130 to place the slider 120 in the second position. If the system 20 is going into a shutdown mode at 210, then at 212 the controller 50 sends a command to the actuator assembly 130 to place the slider 120 in the third position (as shown in FIG. 3). The ability to shift the slider 120 when the system is not running provides operating options that are not available using conventional valves that rely on system pressure to control valve position. The third position shown in FIG. 3 is just one example of slider positioning when the system is not running. It is understood that other slider positions may be employed when the system is not running.

Embodiments provide for moving the slider at a controlled and varying rate. This reduces disturbances experienced in conventional four-way valves and reduces noise. The actuator assembly does not rely on pressure differential which avoids the valve being stuck in an unwanted position. The actuator assembly does not require continuous power, which saves energy.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A heating and cooling system comprising:
a compressor having a discharge outlet and a suction inlet;
a first heat exchanger;
a second heat exchanger;
a four-way valve comprising:
a body including a first port connected to the discharge outlet, a second port connected to the first heat exchanger, a third port connected to the suction inlet and a fourth port connected to the second heat exchanger;
a slider positioned in the body; and
an actuator assembly configured to impart linear motion to the slider; and
a controller configured to send a command to the actuator assembly to move the slider to one of a first position, a second position or a third position.

2. The heating and cooling system of claim 1, wherein when the slider is in the first position, the third port is fluidly coupled to the fourth port, the first position corresponding to a cooling mode.

3. The heating and cooling system of claim 1, wherein when the slider is in the second position, the second port is fluidly coupled to the third port, the second position corresponding to a heating mode.

4. The heating and cooling system of claim 1, wherein when the slider is in the third position, the second port is fluidly coupled to the fourth port, the third position corresponding to a shutdown mode.

5. The heating and cooling system of claim 1, wherein the actuator assembly comprises a stepper motor and a worm gear.

6. The heating and cooling system of claim 5, wherein the slider comprises a geared surface to coact with the worm gear.

7. The heating and cooling system of claim 1, wherein the actuator assembly is configured to move the slider when the compressor is not running.

8. A four-way valve comprising:
a body including a first port configured to connect to a discharge outlet of a compressor, a second port configured to connect to a first heat exchanger, a third port configured to connect to a suction inlet of the compressor and a fourth port configured to connect to a second heat exchanger;
a slider positioned in the body; and
an actuator assembly configured to impart linear motion to the slider;
wherein the actuator assembly is configured to move the slider to one of a first position, a second position or a third position.

9. The four-way valve of claim 8, wherein when the slider is in the first position, the third port is fluidly coupled to the fourth port, the first position corresponding to a cooling mode.

10. The four-way valve of claim 8, wherein when the slider is in the second position, the second port is fluidly coupled to the third port, the second position corresponding to a heating mode.

11. The four-way valve of claim 8, wherein when the slider is in the third position, the second port is fluidly coupled to the fourth port, the third position corresponding to a shutdown mode.

12. The four-way valve of claim 8, wherein the actuator assembly comprises a stepper motor and a worm gear.

13. The four-way valve of claim 12, wherein the slider comprises a geared surface to coact with the worm gear.

14. The four-way valve of claim 8, wherein the actuator assembly is configured to move the slider when the compressor is not running.

15. A method of controlling a four-way valve including a body including a first port configured to connect to a discharge outlet of a compressor, a second port configured to connect to a first heat exchanger, a third port configured to connect to a suction inlet of the compressor, a fourth port configured to connect to a second heat exchanger, and a slider positioned in the body, the method comprising:
in a cooling mode, positioning the slider in a first position to fluidly couple the third port and the fourth port;
in a heating mode, positioning the slider in a second position to fluidly couple the second port and the third port;
in a shutdown mode, positioning the slider in a third position to fluidly couple the second port and the fourth port.

16. The method of claim 15, wherein the slider is configured to move when the compressor is not running.
